(19) United States
(12) Patent Application Publication
(10) Pub. No.: US 2026/0246748 A1
(43) Pub. Date: Aug. 20, 2026

(54) CONTENT INTEGRATION AMONG CONVERSATION CELLS

(71) Applicant: Snap Inc., Santa Monica, CA (US)

(72) Inventors: Isabelle Albi, Los Angeles, CA (US); David Boyle, West Hollywood, CA (US); Stephanie Engle, San Francisco, CA (US); Peter Eugene Horgan, Marina Del Rey, CA (US); Shuangshuang Li, Los Angeles, CA (US); Celia Nicole Mourkogiannis, Los Angeles, CA (US); Evan Spiegel, Los Angeles, CA (US)

(21) Appl. No.: 19/054,250

(22) Filed: Feb. 14, 2025

(51) Int. Cl. H04L 51/10; G06F 3/04817; G06F 3/0482; H04L 51/04

(52) U.S. Cl. CPC H04L 51/10; G06F 3/04817; G06F 3/0482; H04L 51/04

(57) ABSTRACT

Examples relate to systems and methods for integrated content in a conversation interface of a messaging system. The system presents a conversation interface comprising a plurality of conversation cells, each of the plurality of conversation cells corresponding to a different conversation between an individual user and one or more users in a set of users, the set of users being associated with the individual user. The system detects a condition for presenting sponsored content to the individual user and, in response, generates a sponsored conversation cell associated with the sponsored content. The system presents the sponsored conversation cell among the plurality of conversation cells in the conversation interface, the sponsored conversation cell comprising a visual indicator that identifies the sponsored conversation cell as being associated with the sponsored content.

### TECHNICAL FIELD

The present disclosure relates to computer graphics technologies, specifically to presenting content among conversation cells on user devices.

### BACKGROUND

Messaging platforms face technical challenges in efficiently integrating different types of content while maintaining seamless user interactions. Current approaches maintain separate interface frameworks and duplicative components that waste computational resources and fragment the user experience across multiple presentation layers. Rather than leveraging existing chat interface components and interaction patterns that users are already familiar with, conventional systems implement parallel content delivery mechanisms that use additional tracking systems, engagement metrics, and user interface elements.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a data structure as maintained in a database, according to some examples.

FIG. 4 is a diagrammatic representation of a message, according to some examples.

FIG. 5 illustrates a conversation interface that presents sponsored content, according to some examples.

FIG. 6 illustrates a conversation interface that presents sponsored content, according to some examples.

FIG. 7 illustrates a conversation interface that presents sponsored content, according to some examples.

FIG. 8 illustrates a user interface that presents sponsored content, according to some examples.

FIG. 9 is a flowchart illustrating a routine (e.g., a method or process), according to some examples.

FIG. 10 illustrates a system including the head-wearable apparatus, according to some examples.

FIG. 11 is a diagrammatic representation of a machine in the form of a computer system within which a set of instructions may be executed to cause the machine to perform any one or more of the methodologies discussed herein, according to some examples.

FIG. 12 is a block diagram showing a software architecture within which examples may be implemented.

### DETAILED DESCRIPTION

The description that follows discusses illustrative examples of the disclosure. In the following description, for the purposes of explanation, numerous specific details are set forth to provide an understanding of various examples of the disclosed subject matter. It will be evident, however, to those skilled in the art, that examples of the disclosed subject matter may be practiced without these specific details. In general, well-known instruction instances, protocols, structures, and techniques are not necessarily shown in detail.

Conventional approaches for integrating sponsored content (e.g., advertisements) into messaging platforms are inefficient and waste resources by disrupting the natural flow of conversations and requiring separate interfaces or dedicated advertising sections that fragment the user experience. Current systems typically present sponsored content in ways that feel foreign to the messaging experience, such as through intrusive pop-ups or dedicated ad sections that require additional user interface components and computational resources to manage separate presentation layers. These approaches waste development resources by maintaining parallel systems for organic content and advertising content, while also creating jarring transitions that diminish user engagement

Conventional systems require building and maintaining separate advertising frameworks that duplicate functionality and waste system resources. This inefficiency extends to both the technical implementation and user experience, as users need to context switch between their conversations and sponsored content interactions. These inefficiencies create particular challenges for maintaining user engagement while monetizing messaging platforms.

Moreover, advertisers waste significant resources creating and delivering sponsored content that fail to generate meaningful engagement because they are presented in ways that feel disconnected from the natural messaging experience. Traditional advertising approaches force sponsored content into formats that users perceive as intrusive or irrelevant because advertisers develop separate creative assets and delivery mechanisms that fail to resonate with users who are accustomed to more organic, conversational interactions. This misalignment results in wasted advertising spending and development resources, as users are less likely to engage with or respond to sponsored content that appears as an obvious interruption rather than a natural extension of their messaging experience. The inefficiency is particularly evident in how advertisers create specialized sponsored content formats.

The disclosed examples improve the efficiency of using the electronic device by providing a system that seamlessly integrates sponsored content into conversation interfaces. This is performed without requiring separate advertising frameworks or duplicative interface components. Specifically, the disclosed techniques leverage existing chat or conversation interface components to present sponsored conversation cells that appear and behave similarly to organic conversation cells, while including distinct sponsored content indicators and controlled display timing. This approach can eliminate the need for traditional advertising implementations that require maintaining parallel systems for organic and sponsored content. Instead, the disclosed approach utilizes familiar interaction patterns where users can interact with sponsored content through profile icons, conversation cells, and context menus.

By utilizing the existing conversation interface to process sponsored content, the disclosed techniques can automatically integrate sponsored content in a way that feels native to the messaging experience without having to use separate presentation layers or additional computational resources. The disclosed techniques improve efficiency by displaying sponsored content in random positions above other conversation cells or between conversation cells and automatically removing the sponsored content when certain criteria is satisfied, such as after threshold viewing durations. The disclosed techniques can leverage existing chat features, such as saving, forwarding, and reacting functionality while selectively disabling inappropriate features, such as video calling and conversation replies. This targeted approach preserves system resources while maintaining user engagement by presenting sponsored content in a format that aligns with how users already interact with the messaging platform.

The disclosed techniques further improve efficiency through intelligent condition detection that ensures sponsored content is only displayed to appropriate users based on age, subscription status, and activity levels, preventing wasted resources on ineffective ad delivery. Additionally, the disclosed techniques conserve resources by utilizing existing chat interface components, such as visual indicators that transition between filled and unfilled states to show content status, rather than implementing separate tracking systems for sponsored content engagement.

### Networked Computing Environment

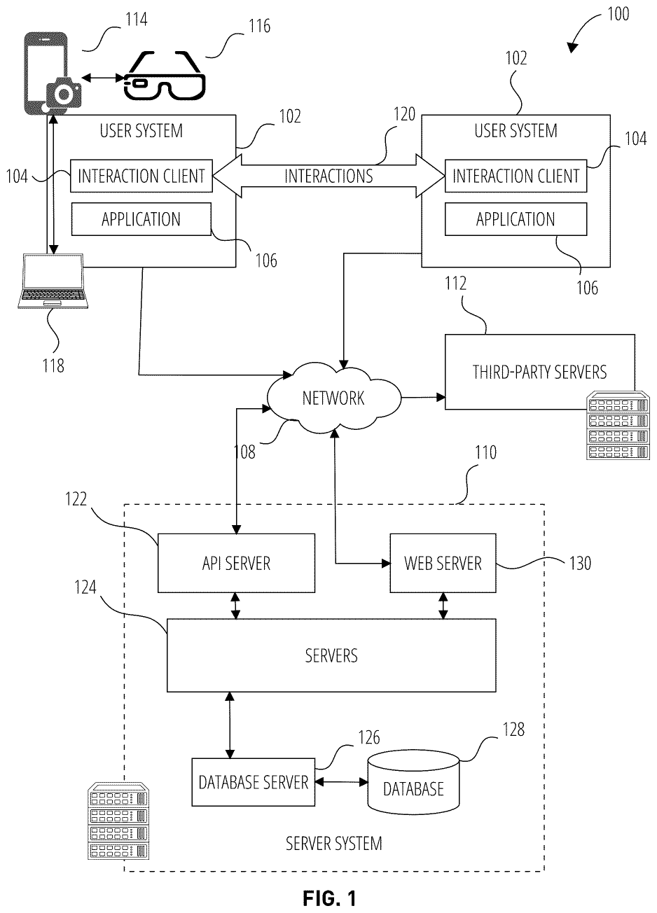

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102 (e.g., user devices) and/or head-wearable apparatus 116, each of which hosts multiple applications, including an interaction client 104 and other applications 106. Each interaction client 104 is communicatively coupled, via one or more networks including a network 108 (e.g., the Internet), to other instances of the interaction client 104 (e.g., hosted on respective other user systems 102), a server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104.

Turning now specifically to the server system 110, an Application Program Interface (API) server 122 is coupled to and provides programmatic interfaces to servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 308); the location of friends within an entity relationship graph; and opening an application event (e.g., relating to the interaction client 104).

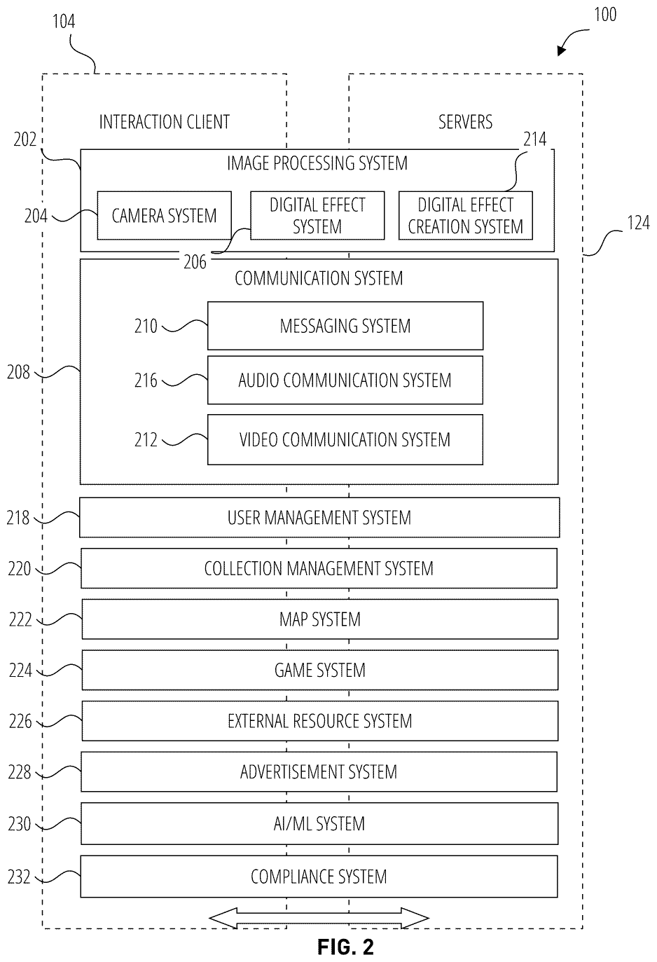

The servers 124 host multiple systems and subsystems, described below with reference to FIG. 2.

### External Resources and Linked Applications

The interaction client 104 provides a user interface that allows users to access features and functions of an external resource, such as a linked application 106, an applet, or a microservice. This external resource may be provided by a third party or by the creator of the interaction client 104.

The external resource may be a full-scale application installed on the user's system 102, or a smaller, lightweight version of the application, such as an applet or a microservice, hosted either on the user's system or remotely, such as on third-party servers 112 or in the cloud. These smaller versions, which include a subset of the full application's features, may be implemented using a markup-language document and may also incorporate a scripting language and a style sheet.

When a user selects an option to launch or access the external resource, the interaction client 104 determines whether the resource is web-based or a locally installed application. Locally installed applications can be launched independently of the interaction client 104, while applets and microservices can be launched or accessed via the interaction client 104.

If the external resource is a locally installed application, the interaction client 104 instructs the user's system to launch the resource by executing locally stored code. If the resource is web-based, the interaction client 104 communicates with third-party servers to obtain a markup-language document corresponding to the selected resource, which it then processes to present the resource within its user interface.

The interaction client 104 can also notify users of activity in one or more external resources. For instance, it can provide notifications relating to the use of an external resource by one or more members of a user group. Users can be invited to join an active external resource or to launch a recently used but currently inactive resource.

The interaction client 104 can present a list of available external resources to a user, allowing them to launch or access a given resource. This list can be presented in a context-sensitive menu, with icons representing different applications, applets, or microservices varying based on how the menu is launched by the user.

In some cases, the external resources include applications that enable shared or multiplayer digital effect applications or experiences and sessions on one or more head-wearable apparatuses 116. In some examples, the external resources include instructions that define functionality to implement respective digital effects experiences. These instructions can include textual prompts that are processed by local or remote implementations of generative machine learning models to generate the digital effects experiences, such as by presented artificially generated or artificially augmented video with one or more digital effects.

The disclosed examples improve the efficiency of using the electronic device by providing a system that seamlessly integrates sponsored content into conversation interfaces. Specifically, the interaction client 104 leverages existing chat or conversation interface components to present sponsored conversation cells that appear and behave similarly to organic conversation cells, while including distinct sponsored content indicators and controlled display timing. This approach can eliminate the need for traditional advertising implementations that require maintaining parallel systems for organic and sponsored content.

### System Architecture

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and modify (e.g., augment, annotate or otherwise edit) media content associated with a message.

A camera system 204 includes control software (e.g., in a camera application) that interacts with and controls camera hardware (e.g., directly or via operating system controls) of the user system 102 to modify real-time images captured and displayed via the interaction client 104.

A digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from memory 1002 of a user system 102. The digital effect system 206 can provide such functions by accessing a set of instructions associated with each respective digital effects experience and processing such instructions by video generative machine learning models in real time. The generative machine learning models can continuously process inputs and/or interactions with the rendered digital effects experiences to update presentation of the digital effects provided by the digital effects experiences. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212. A digital effect(s) application (or digital effects experience experience) is an application configured to provide and display these digital effects and can enable users to engage in multiplayer digital effects sessions using respective head-wearable apparatuses 116 or other user system 102. The digital effect application can be part of the application 106 (and/or interaction client 104) implemented by the user system 102 and/or the head-wearable apparatus 116. In some cases, the digital effect application or output representing the digital effect application can be rendered by a generative machine learning model by processing a set of instructions including prompts that define behavior, goals, and attributes of digital effects relative to real-world or virtual items presented in a video or image in real time. This way, rather than using SLAM or other real-time object tracking and modeling, the digital effects can be presented using fewer hardware and software resources by processing the instructions and generating outputs with the generative machine learning model. In some cases, the prompts can instruct the generative machine learning model (GenAI) to process an image or video of an avatar along with audio input and to generate a video that depicts the avatar (lips of the avatar) speaking speech provided by the audio input.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports AR developer platforms and includes an application for content creators (e.g., artists and developers) to create and publish digital effects (e.g., AR experiences) of the interaction client 104. The digital effect creation system 214 provides a library of built-in features and tools to content creators including, for example custom shaders, tracking technology, and templates. Any functionality that is performed by the digital effect creation system 214 can be replaced and/or augmented by processing instructions with or by a generative machine learning model. In such cases, object tracking and 3D modeling components used by the digital effect creation system 214 can be omitted or skipped as the appropriate output is rendered by the generative machine learning model.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104. In some cases, the communication system 208 can be used to perform the operations discussed for presenting and controlling sponsored conversation cells and sponsored content.

A user management system 218 is operationally responsible for the management of user data and profiles, and maintains entity information (e.g., stored in entity tables 306, entity graphs 308, and profile data 302) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, e.g., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a graphical user interface (GUI) of the interaction client 104 to access features of the web-based external resource, the interaction client 104 obtains the HTML5 file and instantiates the resources to access the features of the web-based external resource.

The interaction client 104 presents a GUI (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and handles the delivery and presentation of these advertisements.

An artificial intelligence and machine learning system 230 provides a variety of services to different subsystems within the digital interaction system 100 including a digital effects experience generation system 504, such as an avatar selection component 516.

For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the digital effect system 206 to generate modified content and augmented reality experiences, such as adding virtual objects or animations to real-world images. The artificial intelligence and machine learning system 230 can access a set of instructions that define an individual digital effects experience. The artificial intelligence and machine learning system 230 can then process such instructions by a generative machine learning model (in some cases along with additional user supplied inputs and/or videos/images) to render an artificial video that depicts digital effects within a real-world or virtual environment defined by the instructions. The artificial intelligence and machine learning system 230 can process such instructions by a generative machine learning model, along with an audio file including user speech and a selected avatar, to render an artificial video that depicts the avatar speaking the speech with synchronized lip movements. The generative machine learning model processes these inputs to generate an animation showing the avatar's lips moving to match the speech patterns, which can be presented within a real-world or virtual environment defined by the instructions.

Machine learning is a field of study that gives computers the ability to learn without being explicitly programmed. The artificial intelligence and machine learning system 230 can be built using machine learning models. Machine learning (e.g., machine learning models) explores the study and construction of algorithms, also referred to herein as tools that may learn from existing data and make predictions about new data. Such machine-learning tools operate by building a model from example training data in order to make data-driven predictions or decisions expressed as outputs or assessments. Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). The machine-learning algorithms use features for analyzing the data to generate an assessment. Each of the features is an individual measurable property of a phenomenon being observed. The concept of a feature is related to that of an explanatory variable used in statistical techniques such as linear regression. Choosing informative, discriminating, and independent features is important for the effective operation of the pattern recognition, classification, and regression. Features may be of different types, such as numeric features, strings, and graphs.

In one example, the features may be of different types and may include one or more of content, concepts, attributes, historical data, and/or user data, merely for example. The machine-learning algorithms use the training data to find correlations among the identified features that affect the outcome or assessment. In some examples, the training data includes labeled data, which is known data for one or more identified features and one or more outcomes, such as detecting communication patterns, detecting the meaning of the message, generating a summary of a message, detecting action items in messages detecting urgency in the message, detecting a relationship of the user to the sender, calculating score attributes, calculating message scores, detecting an error in an uncorrected gaze vector, etc.

With the training data and the identified features, the machine-learning tool is trained at machine-learning program training. The machine-learning tool appraises the value of the features as they correlate to the training data. The result of the training is the trained machine-learning program. When the trained machine-learning program is used to perform an assessment, new data is provided as an input to the trained machine-learning program, and the trained machine-learning program generates the assessment as output.

The machine-learning program supports two types of phases, namely a training phase and prediction phase. In training phases, supervised learning, unsupervised learning, or reinforcement learning may be used. For example, the machine-learning program (1) receives features (e.g., as structured or labeled data in supervised learning) and/or (2) identifies features (e.g., unstructured or unlabeled data for unsupervised learning) in training data. In prediction phases, the machine-learning program uses the features for analyzing query data to generate outcomes or predictions (as examples of an assessment).

In the training phase, feature engineering is used to identify features and may include identifying informative, discriminating, and independent features for the effective operation of the machine-learning program in pattern recognition, classification, and regression. In some examples, the training data includes labeled data, which is known data for pre-identified features and one or more outcomes. Each of the features may be a variable or attribute, such as individual measurable property of a process, article, system, or phenomenon represented by a data set (e.g., the training data).

In training phases, the machine-learning program uses the training data to find correlations among the features that affect a predicted outcome or assessment. With the training data and the identified features, the machine-learning program is trained during the training phase at machine-learning program training. The machine-learning program appraises values of the features as they correlate to the training data. The result of the training is the trained machine-learning program (e.g., a trained or learned model).

Further, the training phases may involve machine learning, in which the training data is structured (e.g., labeled during preprocessing operations), and the trained machine-learning program implements a relatively simple neural network capable of performing, for example, classification and clustering operations. In other examples, the training phase may involve deep learning, in which the training data is unstructured, and the trained machine-learning program implements a deep neural network that is able to perform both feature extraction and classification/clustering operations.

A neural network generated during the training phase, and implemented within the trained machine-learning program, may include a hierarchical (e.g., layered) organization of neurons. For example, neurons (or nodes) may be arranged hierarchically into a number of layers, including an input layer, an output layer, and multiple hidden layers. Each of the layers within the neural network can have one or many neurons, and each of these neurons operationally computes a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which defines the influence of the input from a transmitting neuron to a receiving neuron.

In some examples, the neural network may also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), a Generative Adversarial Network (GAN), and/or a Recursive Neural Network (RNN), merely for example.

During prediction phases, the trained machine-learning program is used to perform an assessment. Query data is provided as an input to the trained machine-learning program, and the trained machine-learning program generates the assessment as output, responsive to receipt of the query data.

For training the generative machine learning model to animate sponsored content characters, the training data includes pairs of audio files containing speech and corresponding video data showing synchronized lip movements and facial expressions that match the personality and style of advertiser-specific characters. The model learns to identify key features in the speech audio, such as phonemes, timing, and emotional tone that align with the character's traits, and correlate these with appropriate character-specific animations. During the training phase, the model processes structured training data that includes labeled pairs of speech audio and corresponding facial animations. Feature engineering focuses on extracting relevant characteristics from both the audio input (such as speech patterns, pauses, and tonal variations) and the animation output (such as lip positions, facial expressions, and temporal synchronization) that maintain the character's unique personality and mannerisms.

The neural network architecture implemented for character animation includes specialized components like Generative Adversarial Networks (GANs) that can generate realistic facial animations matching the advertised character's appearance, and Recurrent Neural Networks (RNNs) that can process the temporal aspects of speech while maintaining character consistency. The model learns to generate smooth, natural-looking animations that accurately reflect both the timing and characteristics of the input speech as well as the character's distinct traits. In the prediction phase, when processing new user speech input, the trained model analyzes the audio features and generates corresponding character animations in real-time that preserve the character's unique personality. The model can handle various speech modifications, including language translation and emotional style changes, by learning correlations between different speech patterns and appropriate character-specific animation responses.

The artificial intelligence and machine learning system provides chatbot functionality that enables interactive conversations between users and advertiser characters, allowing the characters to maintain consistent personalities and behaviors across interactions. The system leverages speech recognition and natural language processing capabilities to enable voice-based interactions with the characters while preserving their distinct traits and mannerisms. This enables advertisers to create engaging sponsored content experiences where users can interact with characters from movies or other advertised content in a natural conversational way that maintains character authenticity.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws.

### Data Architecture

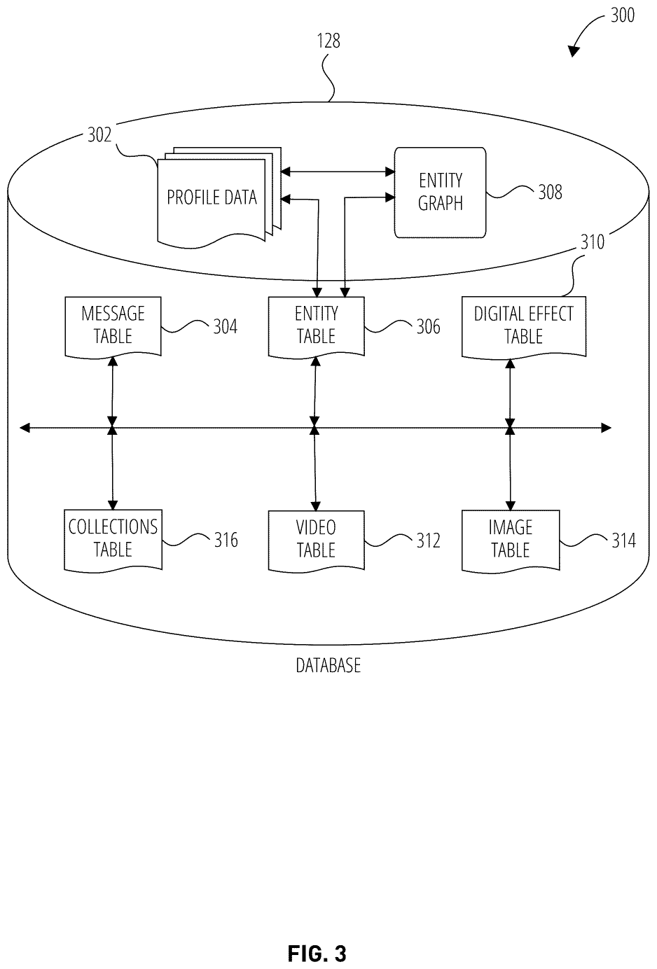

FIG. 3 is a schematic diagram illustrating data structures 300, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 304. This message data includes at least message sender data, message recipient (or receiver) data, and a payload. Further details regarding information that may be included in a message, and included within the message data stored in the message table 304, are described below with reference to FIG. 3.

An entity table 306 stores entity data, and is linked (e.g., referentially) to an entity graph 308 and profile data 302. Entities for which records are maintained within the entity table 306 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 306. Such privacy settings may be applied to all types of relationships within the context of the digital interaction system 100, or may selectively be applied to certain types of relationships.

The profile data 302 stores multiple types of profile data about a particular entity. The profile data 302 may be selectively used and presented to other users of the digital interaction system 100 based on privacy settings specified by a particular entity. Where the entity is an individual, the profile data 302 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 128 also stores digital effect data, such as overlays or filters, in a digital effect table 310. The digital effect data is associated with and applied to videos (for which data is stored in a video table 312) and images (for which data is stored in an image table 314).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data (e.g., instructions that define one or more digital effects experiences) that may be stored within the image table 314 includes augmented reality content items (e.g., corresponding to augmented reality experiences). An augmented reality content item may be a real-time special effect and sound that may be added to an image or a video.

A collections table 316 stores data regarding collections of messages and associated image, video, or audio data, which are compiled into a collection (e.g., a narrative or a gallery). The creation of a particular collection may be initiated by a particular user (e.g., each user for which a record is maintained in the entity table 306). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 312 stores video data that, in some examples, is associated with messages for which records are maintained within the message table 304. Similarly, the image table 314 stores image data associated with messages for which message data is stored in the entity table 306. The entity table 306 may associate various digital effects from the digital effect table 310 with various images and videos stored in the image table 314 and the video table 312.

The databases 128 also include a list of digital effects experiences along with their respective sets of instructions (that define their operation) and/or code that is executed by tracking systems to provide outputs of the digital effects experiences.

### Data Communications Architecture

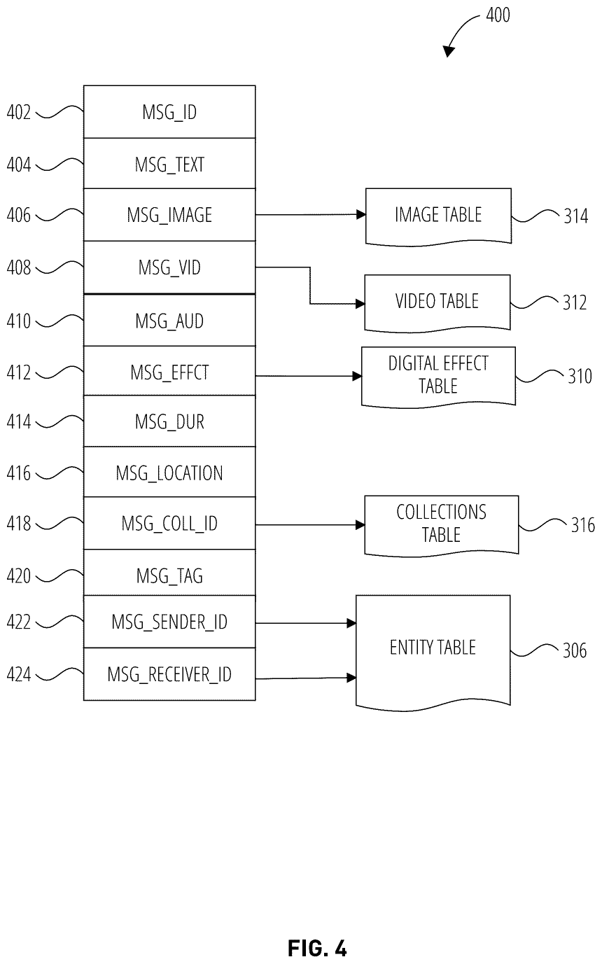

FIG. 4 is a schematic diagram illustrating a structure of a message 400, according to some examples, generated by an interaction client 104 for communication to a further interaction client 104 via the servers 124. The content of a particular message 400 is used to populate the message table 304 stored within the database 128, accessible by the servers 124. Similarly, the content of a message 400 is stored in memory as “in-transit” or “in-flight” data of the user system 102 or the servers 124. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 314.
Message video payload 408: video data, captured by a camera component or retrieved from a memory component of the user system 102, and that is included in the message 400. Video data for a sent or received message 400 may be stored in the video table 312.
Message audio payload 410: audio data, captured by a microphone or retrieved from a memory component of the user system 102, and that is included in the message 400.
Message digital effect data 412: digital effect data (e.g., filters, stickers, or other annotations or enhancements) that represents digital effects to be applied to message image payload 406, message video payload 408, or message audio payload 410 of the message 400. Digital effect data for a sent or received message 400 may be stored in the digital effect table 310.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal, and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message collection identifier 418: identifier values identifying one or more content collections (e.g., “stories” identified in the collections table 316) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 314. Similarly, values within the message video payload 408 may point to data stored within a video table 312, values stored within the message digital effect data 412 may point to data stored in a digital effect table 310, values stored within the message collection identifier 418 may point to data stored in a collections table 316, and values stored within the message sender identifier 422 and the message receiver identifier 424 may point to user records stored within an entity table 306.

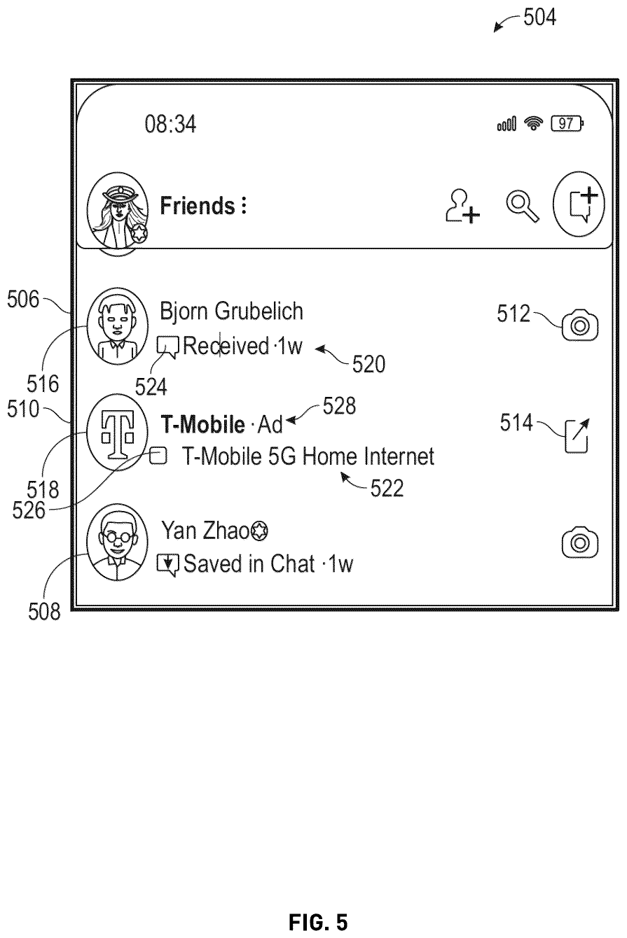

FIG. 5 illustrates a conversation interface 504 that presents sponsored content, according to some examples. Specifically, the conversation interface 504 can be part of the interaction client 104. The interaction client 104 can receive user input that includes a request to access the conversation interface 504, such as from another user interface display (e.g., a video player, or content browser feature). In response, the interaction client 104 can access sponsored content data and profile data 302 associated with an individual user of the interaction client 104. The interaction client 104 can determine whether a condition for presenting sponsored content to the individual user is satisfied.

For example, the interaction client 104 can detect user-specific conditions, such as determining whether the individual user has opened the conversation interface 504, verifying the individual user is above a threshold age of 18 years, confirming the individual user is not subscribed to an advertisement-free subscription tier, and/or checking if the user has been active within a previous time period. In some examples, for age verification, the interaction client 104 queries the profile data 302 stored in the database 128 through the database server 126. The user management system 218 maintains entity information including user age data in entity tables 306, allowing rapid verification against the 18-year threshold. This profile data 302 can be cached and indexed for efficient access during condition checking.

To verify subscription status, the interaction client 104 interfaces with the database 128 to check subscription records. The advertisement system 228 maintains tables of users with ad-free subscription tiers, enabling quick lookups through indexed database queries. When a user opens the conversation interface 504, the interaction client 104 performs a check against these subscription records. If the individual user is associated with an ad-free subscription tier, the interaction client 104 can prevent presenting any sponsored conversation cells or can present a limited number of sponsored conversation cells within a given period of time. If the individual user is not associated with the ad-free subscription tier, the interaction client 104 can select a sponsored content item to generate and present one or more sponsored conversation cells within a particular period of time (which can be less than or greater than the given period of time). For activity verification, the interaction client 104 leverages the collection management system 220 to track user engagement metrics. The interaction client 104 maintains activity timestamps and interaction records in the database 128, allowing efficient queries to determine if users meet activity thresholds within specified time periods.

In some examples, the interaction client 104 implements sophisticated personalized targeting conditions through several interconnected mechanisms. When evaluating birthday-based targeting conditions, the interaction client 104 interfaces with the profile data 302 stored in the database 128 to identify users celebrating birthdays. Upon detecting a birthday condition, the interaction client 104 can automatically trigger delivery of specialized sponsored content, such as personalized birthday offers or promotional coupons from participating advertisers like Baskin-Robbins. For follow-based targeting scenarios, the interaction client 104 monitors user relationship changes through the entity graph 308. When a user follows a new account, the system can initiate delivery of welcome-oriented sponsored content, allowing advertisers to present personalized introductory messages through sponsored conversation cells that appear naturally within the chat feed.

The interaction client 104 enables flexible account-based targeting by allowing any account to distribute sponsored conversation cells directly through the application interface rather than requiring specialized advertiser tools. This democratized approach supports creator collaborations, where influencers can partner with brands to deliver sponsored content through their own profiles, leveraging their existing follower relationships for more authentic sponsored content delivery. These targeting implementations maintain compliance with core sponsored content requirements through consistent advertisement indicators and adherence to platform policies.

The targeting system also integrates with the platform's analytics infrastructure to optimize content delivery timing. By analyzing metrics like chat feed visits and view durations, the system can intelligently determine optimal moments for presenting personalized sponsored content while maintaining user experience quality. For all targeting scenarios, the interaction client 104 preserves standard sponsored content behaviors including clear sponsored content indicators, controlled display timing, and automatic removal after viewing thresholds are met. This ensures consistent user experience while enabling more personalized and contextually relevant sponsored content delivery.

In some examples, the advertisement system 228 can aggregate these condition results and interfaces with targeting tables to match users with appropriate sponsored content. The interaction client 104 evaluates advertiser targeting criteria stored in campaign metadata against the user's profile data 302 and activity metrics. A ranking algorithm processes these matches to select the highest-ranked sponsored content eligible for display. Once matching sponsored content is identified, the interaction client 104 generates a sponsored conversation cell by combining advertiser assets (stored in the digital effect table 310) with standardized conversation cell templates. The message table 304 stores the generated sponsored content with appropriate metadata flags to enable proper rendering within the conversation interface 504. This backend processing can occur rapidly through optimized database queries and caching mechanisms, ensuring sponsored content can be seamlessly integrated when conditions are met without impacting interface performance.

In some examples, for profile matching conditions, the interaction client 104 can analyze targeting criteria to determine if a user matches advertiser requirements. This can include checking country-specific targeting capabilities with availability. The interaction client 104 can also evaluate responsible monetization criteria. The interaction client 104 can, in some cases, exclude presenting sponsored content to new users, such as users who have been members of the interaction client 104 for less than 14 days.

For global broadcast conditions, the interaction client 104 can detect whether an advertiser has scheduled a takeover campaign for a specific time period. These takeover campaigns can begin at midnight local time and are deliverable for 24 hours, with the interaction client 104 ensuring delivery within specific service level agreements. The interaction client 104 can implement sophisticated targeting tables that enable filtering based on country and age breakouts, allowing advertisers to target specific demographics while maintaining efficient resource utilization. For example, some advertisers may specifically target users aged 18+ due to their internal policies.

The condition detection system of the interaction client 104 can also include safeguards to prevent excessive ad exposure, such as implementing ad load frequency caps and avoiding showing ads to users who already see high volumes of content ads. Additionally, the interaction client 104 can enforce a rule to prevent showing more than one sponsored ad in the conversation interface at a time. The interaction client 104 can also evaluate user engagement patterns to determine optimal ad placement timing. By analyzing metrics including chat feed visits and view durations, the interaction client 104 can intelligently determine when conditions are appropriate for presenting sponsored content. These conditions work together to ensure sponsored content is delivered efficiently while maintaining user experience.

In some examples, the interaction client 104 can determine, based on the above, that a condition for presenting the sponsored conversation cell is satisfied. In such cases, the interaction client 104 can present the conversation interface 504 which includes a mix of both first conversation cell 506 and second conversation cell 508 associated with conversations the individual user has with other users (e.g., friends) and a sponsored conversation cell 510. The interaction client 104 can present the sponsored conversation cell 510 in various random positions within the conversation interface 504 while maintaining visibility above the fold. “Above the fold” in the context of the conversation interface 504 refers to the initially visible portion of the chat feed that users can see without scrolling. Specifically, the sponsored conversation cell may appear within the top several visible rows when a user first opens the conversation interface 504. The system ensures visibility by placing the sponsored conversation cell 510 in any position within approximately the top ten rows that are immediately visible to users when they access their chat feed. This placement requirement helps ensure the sponsored conversation cell 510 receives adequate exposure while maintaining a natural feel within the conversation flow.

When new messages are received after the sponsored conversation cell 510 is inserted, those messages can appear in respective conversation cells (e.g., first conversation cell 506) above the sponsored conversation cell 510 following normal chronological ordering, but the initial placement ensures the sponsored conversation cell 510 begins in a visible position without requiring user scrolling. This approach balances visibility requirements with natural conversation flow while maintaining efficient resource utilization.

The interaction client 104 determines placement such that the sponsored conversation cell 510 appears in any position among the first several visible conversation cells, but not specifically pinned to a fixed location. This randomization ensures that for a given user, the sponsored content does not always appear in the same spot, creating a more natural integration with organic conversations. For example, the sponsored conversation cell 510 may be positioned either above all other conversation cells (e.g., first conversation cell 506 and second conversation cell 508) or inserted between first conversation cell 506 and second conversation cell 508. If the individual user receives or sends new messages after the sponsored conversation cell 510 is inserted, those new conversations appear above the sponsored conversation cell 510 according to normal chronological ordering, pushing the sponsored cell lower in the feed while maintaining its visibility.

The interaction client 104 implements this random positioning differently across users, so two users accessing their conversation interfaces simultaneously on different user systems 102 may see the same sponsored conversation cell 510 in different positions within their respective feeds. This distributed approach helps prevent sponsored content from appearing artificial or forced while ensuring consistent visibility across the user base. In some cases, the interaction client 104 places sponsored conversation cells below any pinned messages but maintains the requirement for above-the-fold visibility. The interaction client 104 continues to display the sponsored conversation cell 510 in its assigned position until a specified impression is logged (e.g., the specified impression can be defined as the sponsored conversation cell 510 being 50% or more visible for at least 1 second), after which it is removed during the next feed session when the user exits and returns to the conversation interface 504).

In some examples, the sponsored conversation cell 510 is visually distinguished from other conversation cells, such as first conversation cell 506 and second conversation cell 508 in several ways. For example, the sponsored conversation cell 510 can be presented with a generic visual indicator 528. The generic visual indicator 528 can include textual and/or graphical content that indicates to the individual user that the sponsored conversation cell 510 is associated with sponsored content. The sponsored conversation cell 510 can include a weblink option 514 instead of a video call option 512 because there may be no way to communicate with the advertiser by video.

The sponsored conversation cell 510 can include a brand headline 522 that provides some context and brief description of the sponsored content. The brand headline 522 can be placed at a same relative position as the timestamp 520 is provided for the first conversation cell 506 and the second conversation cell 508. The sponsored conversation cell 510 implements a strategic placement of the brand headline 522 that efficiently utilizes the same visual space usually reserved for timestamps in regular conversation cells. Specifically, where the first conversation cell 506 and second conversation cell 508 display timestamps 520 indicating interaction times (e.g., “Received-1w”), the sponsored conversation cell 510 instead presents descriptive text about the sponsored content in that same relative location.

This placement approach maintains visual consistency within the conversation interface 504 while repurposing the timestamp area for advertising content. For example, where a regular conversation shows “Saved in Chat 1w”, the sponsored conversation cell 510 displays advertiser messaging like “T-Mobile 5G Home Internet” in the corresponding position. The brand headline 522 can appear beneath the advertiser name (e.g., T-Mobile) and adjacent to the sponsored content indicator (e.g., sponsored profile icon 518), creating a cohesive visual hierarchy that clearly identifies the content as sponsored while maintaining the familiar chat interface layout. The interaction client 104 supports truncation of brand headlines when necessary, though specific character limits are configurable to ensure optimal presentation. This design choice deliberately omits displaying a timestamp for the sponsored conversation cell 510 while maintaining timestamps for regular conversation cells, allowing the interface to efficiently utilize this space for advertiser messaging without disrupting the overall visual structure of the conversation interface 504.

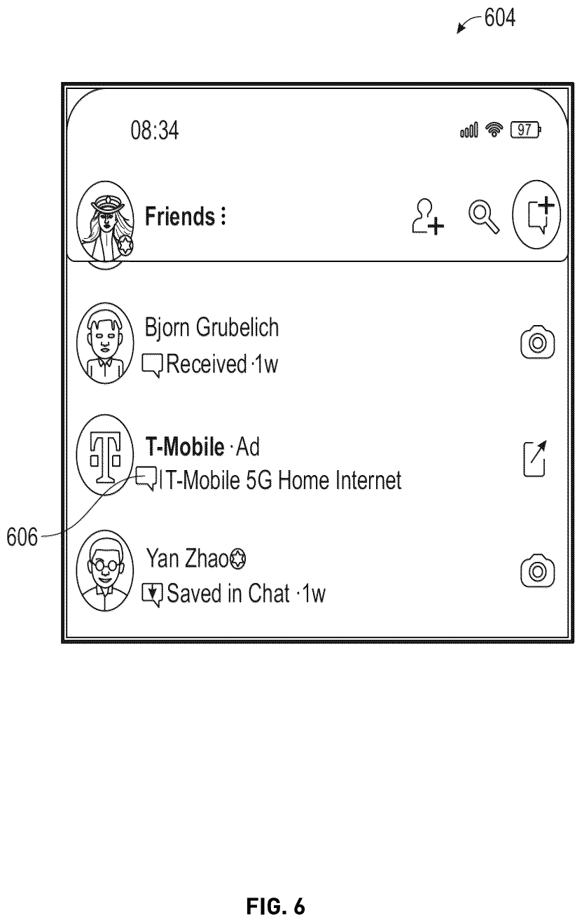

In some examples, the interaction client 104 displays visual indicators within the conversation interface to efficiently communicate content status to users. Specifically, the interaction client 104 implements a second visual indicator 526 within the sponsored conversation cell 510 that transitions between two distinct states (e.g., first and second states). These states include a filled state when the sponsored content associated with the sponsored conversation cell 510 is unviewed and an unfilled state after the sponsored content has been viewed by the individual user. For example, as shown in FIG. 6, the chat interface 604 presents the sponsored conversation cell 510 with the visual indicator 606 in the unfilled or second state. This can be the case after the sponsored conversation cell 510 is selected by the individual user (e.g., tapped for less than a threshold period of time) and the corresponding sponsored content has been presented and exited. Namely, the visual indicator 606 indicates or informs the individual user that the corresponding sponsored content has already been viewed.

Similarly, the interaction client 104 displays a first visual indicator 524 within regular conversation cells (e.g., first conversation cell 506) that follows the same state transition pattern, where a first visual state (e.g., a solid purple square) indicates unviewed messages in the corresponding conversation and transitions to a second visual state (e.g., an empty square outline) after messages within that first conversation cell 506 have been viewed. This consistent visual feedback system allows users to quickly identify unviewed content across both sponsored and regular conversations while maintaining familiar interaction patterns within the conversation interface 504. The visual indicators appear as squares positioned within their respective conversation cells, with the state transitions occurring automatically as users interact with the content, eliminating the need for separate tracking systems to monitor content engagement.

In some cases, the interaction client 104 can display circular indicators (e.g., instead of square indicators) that transition from a filled dot to an empty ring after content is viewed, or triangular indicators that transform from a solid triangle to just the triangle outline to show viewing status. Additionally, the interaction client 104 supports emoji-based indicators that can transition between different emotional states—for example, changing from an excited face to a satisfied expression after content is consumed, while maintaining the same visual feedback purpose as the standard square indicators. The interaction client 104 can also implement animated transitions between states, such as a progress ring that gradually empties as content is viewed or a pulsing effect that fades out once the content has been seen.

In some cases, after the sponsored content is viewed, the sponsored conversation cell 510 is removed and is no longer displayed the next time the conversation interface 504 is accessed. For example, the interaction client 104 implements sophisticated content removal logic for sponsored conversation cells based on viewing thresholds and user navigation patterns. Specifically, when a user views the sponsored content associated with the sponsored conversation cell 510, the interaction client 104 tracks the viewing duration to determine if it qualifies as a specified (billed) impression. In one example, the specified impression can be defined as having the sponsored conversation cell 510 50% or more visible for at least 1 second continuously. Once this viewing threshold is met, the interaction client 104 flags the sponsored content for removal, but may not remove the sponsored conversation cell 510 immediately while the user remains in the conversation interface 504.

Instead, the removal can occur during the next “feed session”—which is the next time the user exits the conversation interface 504 and then returns. For example, if a user views the sponsored content from T-Mobile associated with the sponsored conversation cell 510, then navigates to another tab in the application (like the camera or content browsing section) and later returns to the conversation interface 504, the previously viewed sponsored conversation cell 510 will no longer appear. This approach ensures smooth transitions and prevents jarring content removals while users are actively viewing their chat feed. However, if the user has meaningfully engaged with the sponsored content (such as by replying with a chat or image), the interaction client 104 may persist the sponsored conversation cell 510 for multiple subsequent sessions or up to 24 hours to enable continued interaction. This persistence logic allows users who find the sponsored content relevant to maintain access to it for a longer period while still ensuring eventual removal to maintain feed cleanliness.

The removal process can be handled automatically by the expiration logic of the interaction client 104. The expiration logic can evaluate both the impression criteria and user navigation patterns to determine when to remove the sponsored conversation cell 510. This approach helps maintain an uncluttered conversation interface 504 while ensuring sponsored content receives adequate exposure before being removed.

In some examples, the interaction client 104 can detect input that selects the sponsored profile icon 518 of the sponsored conversation cell 510. In response, the interaction client 104 can navigate the individual user to a specified page (e.g., a weblink) associated with the sponsored content or advertiser or to a playlist of content items associated with the sponsored conversation cell 510. For example, the interaction client 104 implements sophisticated profile icon selection handling for sponsored conversation cells. When a user selects the sponsored profile icon 518, the interaction client 104 processes the interaction differently than standard conversation cell interactions.

Specifically, if the advertiser has live and unviewed story content (e.g., a playlist of content items) available, selecting the profile icon 518 will first attempt to present that story content. If no live story is available or if the story has already been viewed, the interaction client 104 will instead present the advertiser's public profile. The interaction client 104 maintains a collection of content items associated with the advertiser that can be accessed through this profile selection. For example, when viewing content from an advertiser like T-Mobile, selecting their sponsored profile icon 518 could lead to a playlist of promotional content or their brand story. This behavior mirrors the standard conversation cell interaction pattern where selecting a user's profile icon 516 shows their story if available or their public profile as a fallback. However, for sponsored content, the interaction client 104 specifically tailors the experience to present advertiser-specific content collections.

The interaction client 104 also supports advanced features like allowing advertisers to run content from different profiles. For example, a movie studio could present content from either their main studio account or a movie-specific profile, enabling testing of different content delivery approaches. Additionally, the interaction client 104 can integrate with creator collaborations, allowing sponsored content to be presented through creator profiles when appropriate partnership agreements are in place. When displaying advertiser content through profile selection, the interaction client 104 maintains consistent sponsored content indicators and sponsored content markings to ensure transparency while providing seamless access to additional branded content.

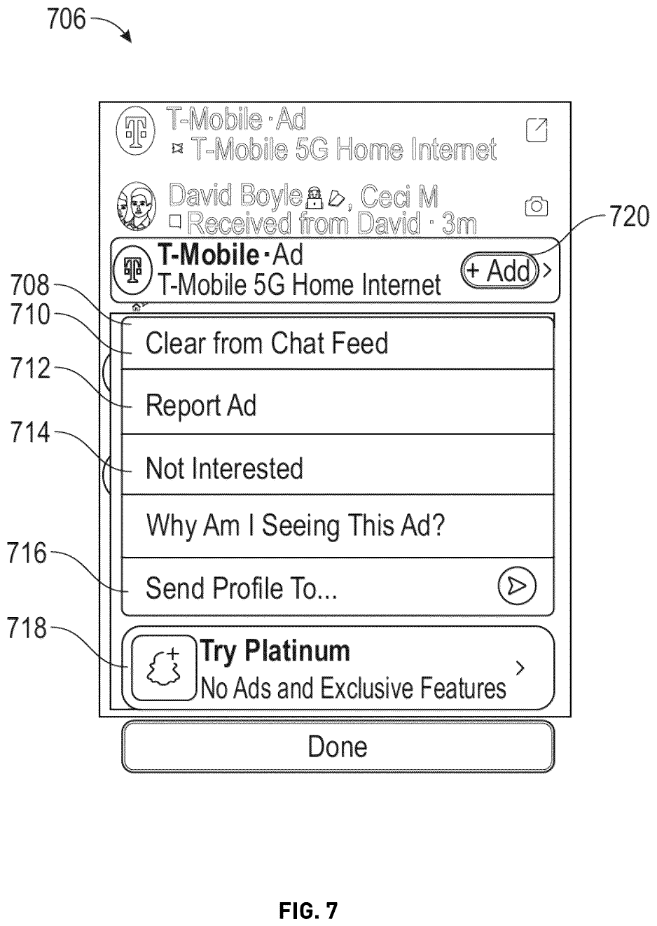

In some examples, the interaction client 104 implements sophisticated long-press detection through hardware-level touch input monitoring. When a user performs a sustained press on the sponsored conversation cell 510, the interaction client 104 measures both the duration and pressure of the touch input to distinguish it from standard taps or scrolling gestures. Once a long press is detected (e.g., a press and hold for a threhsold period of time), the interaction client 104 triggers the display of a context menu 708, shown in FIG. 7, that overlays the conversation interface while maintaining visibility of the underlying content.

FIG. 7 illustrates a conversation chat interface 706 that presents sponsored content, according to some examples. The context menu 708 implementation leverages the existing chat interface frameworks while providing specialized options specific to sponsored content. When displaying the menu, the system positions it relative to the touched location while ensuring all options remain visible within the screen bounds. The menu appears with a subtle animation to provide visual feedback of the successful long press detection.

Each menu option is implemented as a distinct interactive element with appropriate touch targets and spacing to prevent accidental selections. The “Clear from Chat Feed” option (e.g., first option 710) triggers immediate removal of the sponsored cell through the messaging system's content management functions. The “Report Ad” selection option (e.g., second option 712) interfaces with the platform's standard advertisement reporting infrastructure, channeling user feedback through established moderation workflows.

The “Not Interested” functionality (e.g., the third option 714) connects with the sponsored content system's targeting optimization engine, recording user preferences to improve future content relevance. When users select “Why Am I Seeing This Ad?”, the interaction client 104 retrieves and displays targeting criteria and demographic information that led to the sponsored content being shown.

The “Send Profile To . . . ” option (e.g., fourth option 716) integrates with the platform's standard sharing mechanisms while maintaining appropriate sponsored content indicators. For premium subscription upselling, the “Try Platinum” option (e.g., fifth option 718) appears conditionally based on the user's current subscription status, interfacing with the platform's subscription management system.

The context menu 708 can be dismissed through multiple user actions-selecting an option, tapping the “Done” button, or touching outside the menu area. Upon dismissal, the interaction client 104 smoothly animates the menu's removal and returns focus to the conversation interface. This implementation ensures efficient resource utilization by leveraging existing interface components while maintaining clear advertising boundaries and providing specialized sponsored content functionality. The sponsored content option 720 can be selected to access or purchase content or items specifically associated with the advertiser or sponsored content.

The interaction client 104 can deliberately exclude several standard conversation cell context menu options when displaying the sponsored content context menu 708. For regular conversation cells, users may have access to messaging-specific options that are intentionally disabled for sponsored content to maintain appropriate advertising boundaries.

Key excluded options include the ability to send messages or pictures directly through the context menu 708. While regular conversation cells allow users to quickly capture and send photos or videos via menu options, these features are disabled for sponsored content to prevent unwanted media exchanges with advertiser accounts. The interaction client 104 also omits standard chat features like video calling buttons and reply options that would normally appear in conversation cell context menus. This deliberate exclusion helps maintain clear boundaries between advertising and personal communications while preserving system resources.

Message retention controls are also excluded from the sponsored content context menu. Regular conversation cells may include options to pin conversations, modify chat retention settings, and manage message expiration preferences. These controls are intentionally omitted for sponsored content since messages are managed through predetermined advertising display rules. The interaction client 104 excludes typing status indicators and presence information that would normally be available through context menus for regular conversations. These real-time interaction features are disabled for sponsored content since they are not applicable to advertiser communications. Additionally, options related to best friends designation and group chat management are excluded from the sponsored content menu. The interaction client 104 prevents advertiser accounts from appearing in best friend's lists or being added to group conversations, so these standard social features are omitted from the context menu 708.

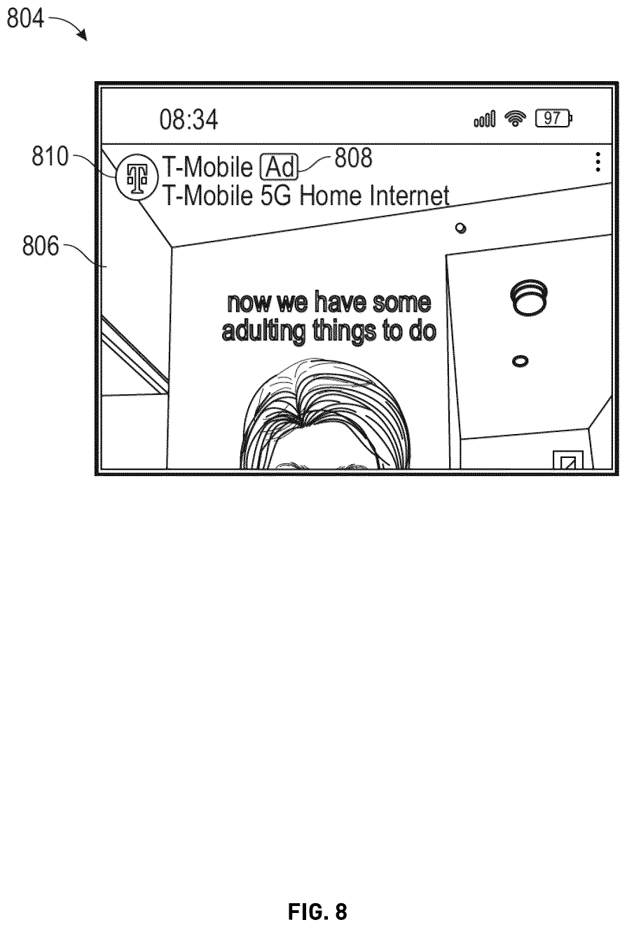

FIG. 8 illustrates a user interface 804 that presents sponsored content, according to some examples. For example, when a user taps anywhere on the sponsored conversation cell 510 outside of the sponsored profile icon 518, the interaction client 104 presents the user interface 804 that displays the sponsored content 806. The sponsored content maintains clear advertising identification through a generic visual indicator 808 and sponsored content information 810.

The user interface 804 presents the sponsored content 806 in a full-screen format, displaying video content (which can include one or more video clips) that automatically loops until user input is received. This behavior differs from regular conversation cells, where tapping would display chat messages or media content with standard playback controls. During sponsored content playback, the interaction client 104 maintains sponsored content indicators and branding elements while providing a streamlined viewing experience. For example, the T-Mobile sponsored content shown in FIG. 8 displays the brand name and sponsored content indicator, shown as sponsored content information 810, at the top of the interface, with the sponsored content playing below or underneath.

The user interface 804 includes specific interaction zones-tapping on the right segment of the screen advances to the next segment if the ad contains multiple parts or video clips, while tapping on other areas can exit the sponsored content view and return to the conversation interface 504. If the sponsored content includes a call-to-action, such as “Get Tickets,” this appears as an interactive element during content playback. The interaction client 104 implements efficient content loading and playback mechanisms, ensuring the sponsored content begins playing immediately upon selection while maintaining clear advertising boundaries through consistent visual indicators and branded elements.

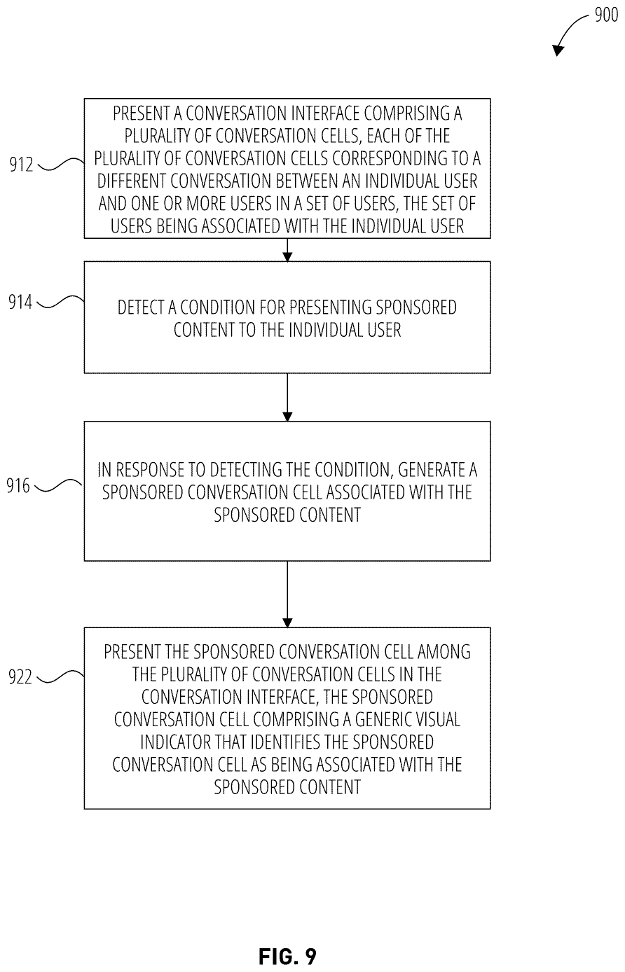

FIG. 9 is a flowchart illustrating routine 900 (e.g., a method or process), according to some examples. Although the example method depicted in FIG. 9 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

In operation 912, the interaction client 104 presents a conversation interface comprising a plurality of conversation cells, each of the plurality of conversation cells corresponding to a different conversation between an individual user and one or more users in a set of users, the set of users being associated with the individual user, as discussed above.

In operation 914, the interaction client 104 detects a condition for presenting sponsored content to the individual user, as discussed above.

In operation 916, the interaction client 104 in response to detecting the condition, generates a sponsored conversation cell associated with the sponsored content, as discussed above.

In operation 922, the interaction client 104 presents the sponsored conversation cell among the plurality of conversation cells in the conversation interface, the sponsored conversation cell comprising a generic visual indicator that identifies the sponsored conversation cell as being associated with the sponsored content, as discussed above.

### System With Head-Wearable Apparatus

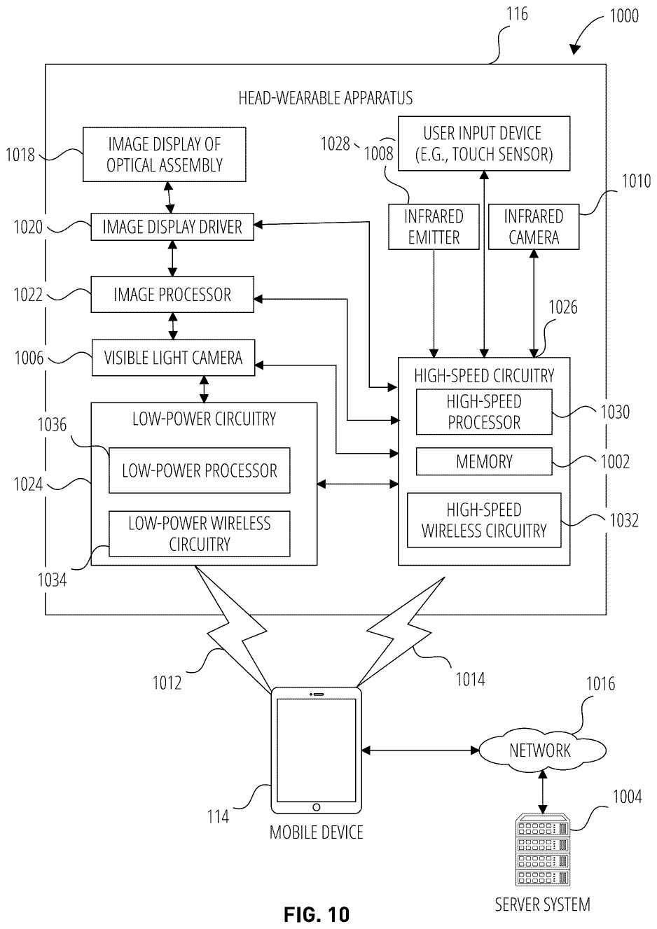

FIG. 10 illustrates a system 1000 including a head-wearable apparatus 116 with a selector input device, according to some examples. FIG. 10 is a high-level functional block diagram of an example head-wearable apparatus 116 communicatively coupled to a mobile device 114 and various server systems 1004 (e.g., the server system 110) via various networks.

The head-wearable apparatus 116 includes one or more cameras, each of which may be, for example, a visible light camera 1006, an infrared emitter 1008, and an infrared camera 1010.

The mobile device 114 connects with head-wearable apparatus 116 using both a low-power wireless connection 1012 and a high-speed wireless connection 1014. The mobile device 114 is also connected to the server system 1004 and the Network 1016.

The head-wearable apparatus 116 further includes two image displays of the image display of optical assembly 1018. The two image displays of optical assembly 1018 include one associated with the left lateral side and one associated with the right lateral side of the head-wearable apparatus 116. The head-wearable apparatus 116 also includes an image display driver 1020, an image processor 1022, low-power circuitry 1024, and high-speed circuitry 1026. The image display of optical assembly 1018 is for presenting images and videos, including an image that can include a graphical user interface to a user of the head-wearable apparatus 116.

The image display driver 1020 commands and controls the image display of optical assembly 1018. The image display driver 1020 may deliver image data directly to the image display of optical assembly 1018 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 1028 (e.g., touch sensor or push button), including an input surface on the head-wearable apparatus 116. The user input device 1028 (e.g., touch sensor or push button) is to receive from the user an input selection to manipulate the graphical user interface of the presented image.

The components shown in FIG. 10 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 1006 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 1002, which stores instructions to perform a subset, or all the functions described herein. The memory 1002 can also include storage device.

As shown in FIG. 10, the high-speed circuitry 1026 includes a high-speed processor 1030, a memory 1002, and high-speed wireless circuitry 1032. In some examples, the image display driver 1020 is coupled to the high-speed circuitry 1026 and operated by the high-speed processor 1030 to drive the left and right image displays of the image display of optical assembly 1018. The high-speed processor 1030 may be any processor capable of managing high-speed communications and operation of any general computing system needed for the head-wearable apparatus 116. The high-speed processor 1030 includes processing resources needed for managing high-speed data transfers on a high-speed wireless connection 1014 to a wireless local area network (WLAN) using the high-speed wireless circuitry 1032. In certain examples, the high-speed processor 1030 executes an operating system such as a LINUX operating system or other such operating system of the head-wearable apparatus 116, and the operating system is stored in the memory 1002 for execution. In addition to any other responsibilities, the high-speed processor 1030 executing a software architecture for the head-wearable apparatus 116 is used to manage data transfers with high-speed wireless circuitry 1032. In certain examples, the high-speed wireless circuitry 1032 is configured to implement Institute of Electrical and Electronic Engineers (IEEE) 802.11 communication standards, also referred to herein as WI-FI®. In some examples, other high-speed communications standards may be implemented by the high-speed wireless circuitry 1032.

The low-power wireless circuitry 1034 and the high-speed wireless circuitry 1032 of the head-wearable apparatus 116 can include short-range transceivers (e.g., Bluetooth™, Bluetooth LE, Zigbee, ANT+) and wireless wide, local, or wide area Network transceivers (e.g., cellular or WI-FI®). Mobile device 114, including the transceivers communicating via the low-power wireless connection 1012 and the high-speed wireless connection 1014, may be implemented using details of the architecture of the head-wearable apparatus 116, as can other elements of the Network 1016.

The memory 1002 includes any storage device capable of storing various data and applications, including, among other things, camera data generated by the left and right visible light cameras 1006, the infrared camera 1010, and the image processor 1022, as well as images generated for display by the image display driver 1020 on the image displays of the image display of optical assembly 1018. While the memory 1002 is shown as integrated with high-speed circuitry 1026, in some examples, the memory 1002 may be an independent standalone element of the head-wearable apparatus 116. In certain such examples, electrical routing lines may provide a connection through a chip that includes the high-speed processor 1030 from the image processor 1022 or the low-power processor 1036 to the memory 1002. In some examples, the high-speed processor 1030 may manage addressing of the memory 1002 such that the low-power processor 936 will boot the high-speed processor 1030 any time that a read or write operation involving memory 1002 is needed.

As shown in FIG. 10, the low-power processor 1036 or high-speed processor 1030 of the head-wearable apparatus 116 can be coupled to the camera (visible light camera 1006, infrared emitter 1008, or infrared camera 1010), the image display driver 1020, the user input device 1028 (e.g., touch sensor or push button), and the memory 1002.

The head-wearable apparatus 116 is connected to a host computer. For example, the head-wearable apparatus 116 is paired with the mobile device 114 via the high-speed wireless connection 1014 or connected to the server system 1004 via the Network 1016. The server system 1004 may be one or more computing devices as part of a service or network computing system, for example, that includes a processor, a memory, and network communication interface to communicate over the Network 1016 with the mobile device 114 and the head-wearable apparatus 116.

The mobile device 114 includes a processor and a network communication interface coupled to the processor. The Network communication interface allows for communication over the Network 1016, low-power wireless connection 1012, or high-speed wireless connection 1014. Mobile device 114 can further store at least portions of the instructions in the memory of the mobile device 114 memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 1020. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 1004, such as the user input device 1028, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include sensors and display elements integrated with the head-wearable apparatus 116. For example, peripheral device elements may include any input/output (I/O) components including output components, motion components, position components, or any other such elements described herein.

In some examples, the head-wearable apparatus 116 may include biometric components or sensors s to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored with only user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 1012 and high-speed wireless connection 1014 from the mobile device 114 via the low-power wireless circuitry 1034 or high-speed wireless circuitry 1032.

### Machine Architecture

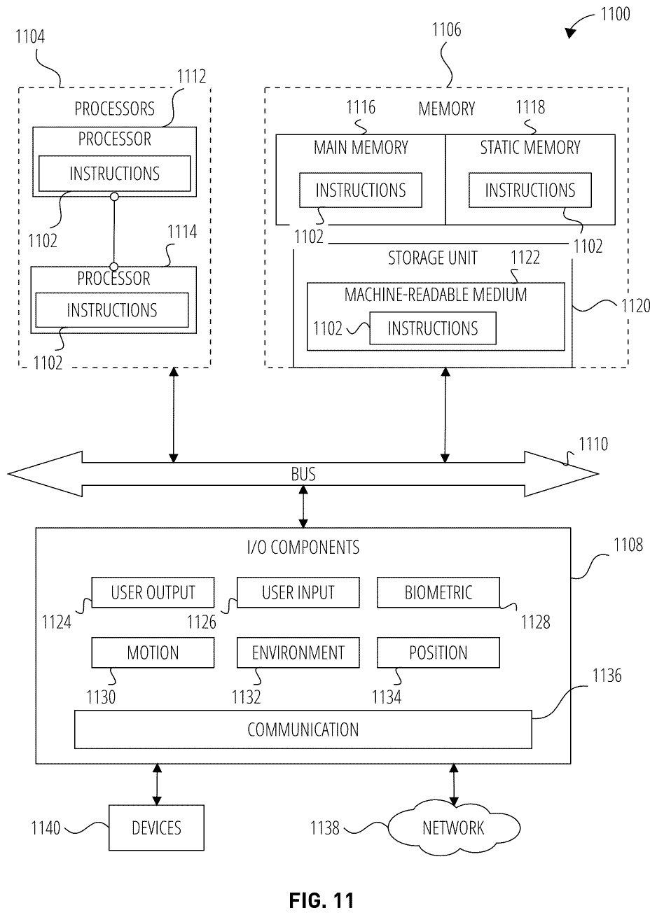

FIG. 11 is a diagrammatic representation of the machine 1100 within which instructions 1102 (e.g., software, a program, an application, an applet, an app, or other executable code) for causing the machine 1100 to perform any one or more of the methodologies discussed herein may be executed. For example, the instructions 1102 may cause the machine 1100 to execute any one or more of the methods described herein. The instructions 1102 transform the general, non-programmed machine 1100 into a particular machine 1100 programmed to carry out the described and illustrated functions in the manner described. The machine 1100 may operate as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1102, sequentially or otherwise, that specify actions to be taken by the machine 1100. Further, while a single machine 1100 is illustrated, the term “machine” shall also be taken to include a collection of machines that individually or jointly execute the instructions 1102 to perform any one or more of the methodologies discussed herein. The machine 1100, for example, may comprise the user system 102 or any one of multiple server devices forming part of the server system 110. In some examples, the machine 1100 may also comprise both client and server systems, with certain operations of a particular method or algorithm being performed on the server-side and with certain operations of the method or algorithm being performed on the client-side.

The machine 1100 may include processors 1104, memory 1106, and input/output I/O components 1108, which may be configured to communicate with each other via a bus 1110.

The memory 1106 includes a main memory 1116, a static memory 1118, and a storage unit 1120, both accessible to the processors 1104 (e.g., processor 1112 or processor 1114 via the bus 1110). The main memory 1106, the static memory 1118, and storage unit 1120 store the instructions 1102 embodying any one or more of the methodologies or functions described herein. The instructions 1102 may also reside, completely or partially, within the main memory 1116, within the static memory 1118, within machine-readable medium 1122 within the storage unit 1120, within at least one of the Processors 1104 (e.g., within the processor's cache memory), or any suitable combination thereof, during execution thereof by the machine 1100.

The I/O components 1108 may include a wide variety of components to receive input, provide output, produce output, transmit information, exchange information, capture measurements, and so on. The specific I/O components 1108 that are included in a particular machine will depend on the type of machine. For example, portable machines such as mobile phones may include a touch input device or other such input mechanisms, while a headless server machine will likely not include such a touch input device. It will be appreciated that the I/O components 1108 may include many other components that are not shown in FIG. 11. In various examples, the I/O components 1108 may include user output components 1124 and user input components 1126. The user output components 1124 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1126 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1108 may include biometric components 1128, motion components 1130, environmental components 1132, or position components 1134, among a wide array of other components. For example, the biometric components 1128 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Any biometric data collected by the biometric components is captured and stored only with user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 1130 include acceleration sensor components (e.g., accelerometer), gravitation sensor components, rotation sensor components (e.g., gyroscope).

The environmental components 1132 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 1108 further include communication components 1136 operable to couple the machine 1100 to a Network 1138 or devices 1140 via respective coupling or connections. For example, the communication components 1136 may include a network interface component or another suitable device to interface with the Network 1138. In further examples, the communication components 1136 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1140 may be another machine or any of a wide variety of peripheral devices (e.g., a peripheral device coupled via a USB).

Moreover, the communication components 1136 may detect identifiers or include components operable to detect identifiers. For example, the communication components 1136 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1136, such as location via Internet Protocol (IP) geolocation, location via Wi-Fi® signal triangulation, location via detecting an NFC beacon signal that may indicate a particular location, and so forth.

The various memories (e.g., main memory 1116, static memory 1118, and memory of the Processors 1104) and storage unit 1120 may store one or more sets of instructions and data structures (e.g., software) embodying or used by any one or more of the methodologies or functions described herein. These instructions (e.g., the instructions 1102), when executed by Processors 1104, cause various operations to implement the disclosed examples.

The instructions 1102 may be transmitted or received over the Network 1138, using a transmission medium, via a network interface device (e.g., a network interface component included in the communication components 1136) and using any one of several well-known transfer protocols (e.g., hypertext transfer protocol (HTTP)). Similarly, the instructions 1102 may be transmitted or received using a transmission medium via a coupling (e.g., a peer-to-peer coupling) to the devices 1140.

### Software Architecture

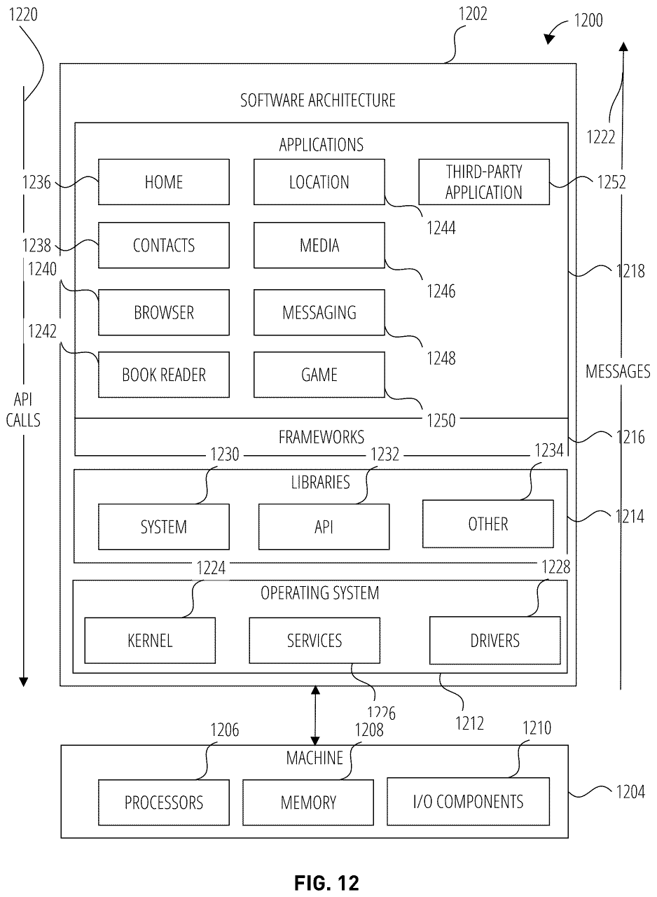

FIG. 12 is a block diagram 1200 illustrating a software architecture 1202, which can be installed on any one or more of the devices described herein. The software architecture 1202 is supported by hardware such as a machine 1204 that includes processors 1206, memory 1208, and I/O components 1210. In this example, the software architecture 1202 can be conceptualized as a stack of layers, where each layer provides a particular functionality. The software architecture 1202 includes layers such as an operating system 1212, libraries 1214, frameworks 1216, and applications 1218. Operationally, the applications 1218 invoke API calls 1220 through the software stack and receive messages 1222 in response to the API calls 1220.

The operating system 1212 manages hardware resources and provides common services. The operating system 1212 includes, for example, a kernel 1224, services 1226, and drivers 1228. The kernel 1224 acts as an abstraction layer between the hardware and the other software layers. For example, the kernel 1224 provides memory management, processor management (e.g., scheduling), component management, networking, and security settings, among other functionalities. The services 1226 can provide other common services for the other software layers. The drivers 1228 are responsible for controlling or interfacing with the underlying hardware. For instance, the drivers 1228 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1214 provide a common low-level infrastructure used by the applications 1218. The libraries 1214 can include system libraries 1230 (e.g., C standard library) that provide functions such as memory allocation functions, string manipulation functions, mathematical functions, and the like. In addition, the libraries 1214 can include API libraries 1232 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1214 can also include a wide variety of other libraries 1234 to provide many other APIs to the applications 1218.

The frameworks 1216 provide a common high-level infrastructure that is used by the applications 1218. For example, the frameworks 1216 provide various graphical user interface (GUI) functions, high-level resource management, and high-level location services. The frameworks 1216 can provide a broad spectrum of other APIs that can be used by the applications 1218, some of which may be specific to a particular operating system or platform.

In an example, the applications 1218 may include a home application 1236, a contacts application 1238, a browser application 1240, a book reader application 1242, a location application 1244, a media application 1246, a messaging application 1248, a game application 1250, and a broad assortment of other applications such as a third-party application 1252. The applications 1218 are programs that execute functions defined in the programs. Various programming languages can be employed to create one or more of the applications 1218, structured in a variety of manners, such as object-oriented programming languages (e.g., Objective-C, Java, or C++) or procedural programming languages (e.g., C or assembly language). In a specific example, the third-party application 1252 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1252 can invoke the API calls 1220 provided by the operating system 1212 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLE STATEMENTS

### Example 1

A system comprising: at least one processor; at least one memory component storing instructions that, when executed by the at least one processor, cause the at least one processor to perform operations comprising: presenting a conversation interface comprising a plurality of conversation cells, each of the plurality of conversation cells corresponding to a different conversation between an individual user and one or more users in a set of users, the set of users being associated with the individual user; detecting a condition for presenting sponsored content to the individual user; in response to detecting the condition, generating a sponsored conversation cell associated with the sponsored content; and presenting the sponsored conversation cell among the plurality of conversation cells in the conversation interface, the sponsored conversation cell comprising a visual indicator that identifies the sponsored conversation cell as being associated with the sponsored content.

### Example 2

The system of Example 1, wherein the operations further comprise: receiving input that presses and holds on the sponsored conversation cell for a threshold period of time; and in response to receiving the input that presses and holds on the sponsored conversation cell for the threshold period of time, displaying a context menu comprising sponsored content options.

### Example 3

The system of Example 2, wherein the sponsored content options of the context menu comprises at least one of: a reporting the sponsored content option, an option for indicating disinterest in the sponsored content, or an option for accessing a call-to-action weblink associated with the sponsored content.

### Example 4

The system of any one of Examples 2-3, wherein the sponsored content options of the context menu comprises a subscription option, the subscription option enabling the individual user to upgrade a subscription to reduce exposure to sponsored content.

### Example 5

The system of any one of Examples 1-4, wherein the operations further comprise: receiving a request to access the conversation interface; and in response to receiving the request, causing the sponsored conversation cell to be presented in an initial page of the conversation interface among an initial set of the plurality of conversation cells.

### Example 6

The system of any one of Examples 1-5, wherein the operations further comprise: disabling, for the sponsored conversation cell, chat interface features.

### Example 7

The system of Example 6, the chat interface features that are displayed comprising at least one of: a video calling option, a reply option, or a typing or presence status indicator.

### Example 8

The system of any one of Examples 1-7, wherein the operations further comprise: determining that the sponsored conversation cell has been displayed within the conversation interface for at least a threshold duration; and in response to determining that the sponsored conversation cell has been displayed within the conversation interface for at least the threshold duration, preventing display of the sponsored conversation cell within the conversation interface in response to subsequent display of the conversation interface, the subsequent display corresponding to presentation of the conversation interface after exiting the conversation interface to access a different user interface.

### Example 9

The system of any one of Examples 1-8, wherein the position is randomly selected from being above all of the plurality of conversation cells or between first and second conversation cells of the plurality of conversation cells.

### Example 10

The system of Example 9, wherein the random position is above all of the plurality of conversation cells or between first and second conversation cells of the plurality of conversation cells.

### Example 11

The system of any one of Examples 1-10, wherein the visual indicator comprises a sponsored content indicator displayed adjacent to an identifier of an advertiser account associated with the sponsored content.

### Example 12

The system of any one of Examples 1-11, wherein the operations further comprise: presenting a plurality of timestamps representing interaction times for each respective conversation cell of the plurality of conversation cells; and omitting display of a timestamp for the sponsored conversation cell while displaying the plurality of timestamps for the plurality of conversation cells.

### Example 13

The system of Example 12, wherein the sponsored conversation cell comprises a brand headline displayed in a relative location corresponding to where timestamps are displayed for the plurality of conversation cells, and the brand headline comprises descriptive text about the sponsored content that is displayed adjacent to an identifier of an advertiser account associated with the sponsored content.

### Example 14

The system of any one of Examples 1-13, wherein the operations further comprise: in response to determining that the individual user has interacted with the sponsored conversation cell, persisting display of the sponsored conversation cell in the conversation interface for a predetermined time period.

### Example 15

The system of any one of Examples 1-14, wherein the operations further comprise: displaying a first visual indicator within the sponsored conversation cell that transitions from a first state to a second state after the sponsored content is viewed; and displaying a second visual indicator within an individual conversation cell of the plurality of conversation cells that transitions from the first state to the second state after messages within the individual conversation cell are viewed.

### Example 16

The system of any one of Examples 1-15, wherein the operations further comprise: in response to receiving a selection of a profile icon presented within the sponsored conversation cell, presenting a playlist of one or more sponsored content items associated with an advertiser of the sponsored content; and in response to receiving a selection of any portion of the sponsored conversation cell outside of the profile icon, presenting the sponsored content associated with the sponsored conversation cell, the sponsored content being different from the playlist of one or more sponsored content items, the sponsored content comprising a video that is looped until user input is received.

### Example 17

The system of Example 16, wherein the operations further comprise: in response to receiving a selection of a profile icon presented within an individual conversation cell of the plurality of conversation cells, presenting a collection of content items associated with a corresponding user of the individual conversation cell; and in response to receiving a selection of any portion of the individual conversation cell outside of the profile icon, presenting one or more messages associated with the individual conversation cell.

### Example 18

The system of Example 17, wherein the collection of content items comprises live and unviewed content that is presented in response to determining that live content (where the content is being viewed by one or more other users as the content is being recorded) is available, and the collection of content items comprises a public profile of the corresponding user when no live content is available, and wherein detecting the condition comprises at least one of: determining that the individual user has opened the conversation interface; determining that the individual user is above a threshold age; determining that the individual user is not subscribed to a sponsored content-free subscription tier; or determining that the individual user has been active within a previous time period.

### Example 19

A computer-implemented method comprising: presenting a conversation interface comprising a plurality of conversation cells, each of the plurality of conversation cells corresponding to a different conversation between an individual user and one or more users in a set of users, the set of users being associated with the individual user; detecting a condition for presenting sponsored content to the individual user; in response to detecting the condition, generating a sponsored conversation cell associated with the sponsored content; and presenting the sponsored conversation cell among the plurality of conversation cells in the conversation interface, the sponsored conversation cell comprising a visual indicator that identifies the sponsored conversation cell as being associated with the sponsored content.

### Example 20

A non-transitory computer-readable storage medium storing instructions that, when executed by at least one processor, cause the at least one processor to perform operations comprising: presenting a conversation interface comprising a plurality of conversation cells, each of the plurality of conversation cells corresponding to a different conversation between an individual user and one or more users in a set of users, the set of users being associated with the individual user; detecting a condition for presenting sponsored content to the individual user; in response to detecting the condition, generating a sponsored conversation cell associated with the sponsored content; and presenting the sponsored conversation cell among the plurality of conversation cells in the conversation interface, the sponsored conversation cell comprising a visual indicator that identifies the sponsored conversation cell as being associated with the sponsored content.

### Term Examples

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations.

A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time.

For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein.

As used herein, “processor-implemented component” may refer to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms “machine-storage medium,” “device-storage medium,” and “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A system comprising:
at least one processor;
at least one memory component storing instructions that, when executed by the at least one processor, cause the at least one processor to perform operations comprising:
presenting a conversation interface comprising a plurality of conversation cells, each of the plurality of conversation cells corresponding to a different conversation between an individual user and one or more users in a set of users, the set of users being associated with the individual user;
detecting a condition for presenting sponsored content to the individual user;
in response to detecting the condition, generating a sponsored conversation cell associated with the sponsored content; and
presenting the sponsored conversation cell among the plurality of conversation cells in the conversation interface, the sponsored conversation cell comprising a visual indicator that identifies the sponsored conversation cell as being associated with the sponsored content.

2. The system of claim 1, wherein the operations further comprise:
receiving input that presses and holds on the sponsored conversation cell for a threshold period of time; and
in response to receiving the input that presses and holds on the sponsored conversation cell for the threshold period of time, displaying a context menu comprising sponsored content options.

3. The system of claim 2, wherein the sponsored content options of the context menu comprise at least one of: a reporting the sponsored content option, an option for indicating disinterest in the sponsored content, or an option for accessing a call-to-action weblink associated with the sponsored content.

4. The system of claim 2, wherein the sponsored content options of the context menu comprise a subscription option, the subscription option enabling the individual user to upgrade a subscription to reduce exposure to additional sponsored content.

5. The system of claim 1, wherein the operations further comprise:
receiving a request to access the conversation interface; and
in response to receiving the request, causing the sponsored conversation cell to be presented in an initial page of the conversation interface among an initial set of the plurality of conversation cells.

6. The system of claim 1, wherein the operations further comprise:
disabling, for the sponsored conversation cell, chat interface features.

7. The system of claim 6, wherein the chat interface features that are displayed comprise at least one of: a video calling option, a reply option, or a typing or presence status indicator.

8. The system of claim 1, wherein the operations further comprise:
determining that the sponsored conversation cell has been displayed within the conversation interface for at least a threshold duration; and
in response to determining that the sponsored conversation cell has been displayed within the conversation interface for at least the threshold duration, preventing display of the sponsored conversation cell within the conversation interface in response to subsequent display of the conversation interface, the subsequent display corresponding to presentation of the conversation interface after exiting the conversation interface to access a different user interface.

9. The system of claim 1, wherein the sponsored conversation cell is presented in a random position in the conversation interface.

10. The system of claim 9, wherein the position is randomly selected from being above all of the plurality of conversation cells or between first and second conversation cells of the plurality of conversation cells.

11. The system of claim 1, wherein the visual indicator comprises a sponsored content indicator displayed adjacent to an identifier of an advertiser account associated with the sponsored content.

12. The system of claim 1, wherein the operations further comprise:
presenting a plurality of timestamps representing interaction times for each respective conversation cell of the plurality of conversation cells; and
omitting display of a timestamp for the sponsored conversation cell while displaying the plurality of timestamps for the plurality of conversation cells.

13. The system of claim 12, wherein the sponsored conversation cell comprises a brand headline displayed in a relative location corresponding to where timestamps are displayed for the plurality of conversation cells, and wherein the brand headline comprises descriptive text about the sponsored content that is displayed adjacent to an identifier of an advertiser account associated with the sponsored content.

14. The system of claim 1, wherein the operations further comprise:
in response to determining that the individual user has interacted with the sponsored conversation cell, persisting display of the sponsored conversation cell in the conversation interface for a predetermined time period.

15. The system of claim 1, wherein the operations further comprise:
displaying a first visual indicator within the sponsored conversation cell that transitions from a first state to a second state after the sponsored content is viewed; and
displaying a second visual indicator within an individual conversation cell of the plurality of conversation cells that transitions from the first state to the second state after messages within the individual conversation cell are viewed.

16. The system of claim 1, wherein the operations further comprise:
in response to receiving a selection of a profile icon presented within the sponsored conversation cell, presenting a playlist of one or more sponsored content items associated with an advertiser of the sponsored content; and
in response to receiving a selection of any portion of the sponsored conversation cell outside of the profile icon, presenting the sponsored content associated with the sponsored conversation cell, the sponsored content being different from the playlist of one or more sponsored content items, the sponsored content comprising a video that is looped until user input is received.

17. The system of claim 16, wherein the operations further comprise:
in response to receiving a selection of a profile icon presented within an individual conversation cell of the plurality of conversation cells, presenting a collection of content items associated with a corresponding user of the individual conversation cell; and
in response to receiving a selection of any portion of the individual conversation cell outside of the profile icon, presenting one or more messages associated with the individual conversation cell.

18. The system of claim 17, wherein the collection of content items comprises live and unviewed content that is presented in response to determining that live content is available, and the collection of content items comprises a public profile of the corresponding user when no live content is available, and wherein detecting the condition comprises at least one of:
determining that the individual user has opened the conversation interface;
determining that the individual user is above a threshold age;
determining that the individual user is not subscribed to a sponsored content-free subscription tier; or
determining that the individual user has been active within a previous time period.

19. A computer-implemented method comprising:
presenting a conversation interface comprising a plurality of conversation cells, each of the plurality of conversation cells corresponding to a different conversation between an individual user and one or more users in a set of users, the set of users being associated with the individual user;
detecting a condition for presenting sponsored content to the individual user;
in response to detecting the condition, generating a sponsored conversation cell associated with the sponsored content; and
presenting the sponsored conversation cell among the plurality of conversation cells in the conversation interface, the sponsored conversation cell comprising a visual indicator that identifies the sponsored conversation cell as being associated with the sponsored content.

20. A non-transitory computer-readable storage medium storing instructions that, when executed by at least one processor, cause the at least one processor to perform operations comprising:
presenting a conversation interface comprising a plurality of conversation cells, each of the plurality of conversation cells corresponding to a different conversation between an individual user and one or more users in a set of users, the set of users being associated with the individual user;
detecting a condition for presenting sponsored content to the individual user;
in response to detecting the condition, generating a sponsored conversation cell associated with the sponsored content; and
presenting the sponsored conversation cell among the plurality of conversation cells in the conversation interface, the sponsored conversation cell comprising a visual indicator that identifies the sponsored conversation cell as being associated with the sponsored content.
